(19) United States
(12) Patent Application Publication
(10) Pub. No.: US 2012/0223698 A1
(43) Pub. Date: Sep. 6, 2012

(54) FAN SPEED TESTING SYSTEM

(75) Inventor: DONG WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/209,694

(22) Filed: Aug. 15, 2011

(30) Foreign Application Priority Data
Mar. 1, 2011 (CN) 201110048789.4

(51) Int. Cl. G01P 3/56

(52) U.S. Cl. 324/161

(57) ABSTRACT

A fan speed testing system for testing the rotational speed of a first fan, includes a switch module, a comparison module and a load module. The switch module outputs control signals. The comparison module receives the control signals and provides a first voltage according to the control signals. The load module receives the first voltage and outputs a second voltage to the first fan. The load module feeds the second voltage received by the first fan back to the comparison module. The comparison module adjusts the first voltage to the load module according to the second voltage received from the load module.

### BACKGROUND

1. Technical Field

The present disclosure relates to testing systems, especially to a testing system for testing the speed of a fan speed.

2. Description of Related Art

Quality tests are required after computers are manufactured. One of the tests is to test the speed of the fans of the computers. A conventional method to test the speed of the fans is by using a tachometer. However, the conventional method requires opening the computer and manually positioning the tachometer close to the fan, which wastes time and labor, and also involves the cost as well, the tachometer is expensive.

Therefore there is a need for improvement in the art.

### BRIEF DESCRIPTION OF THE DRAWINGS

FIG. 1 is a block view of a fan speed testing system in accordance with an embodiment.

FIG. 2 is a circuit view of the embodiment of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

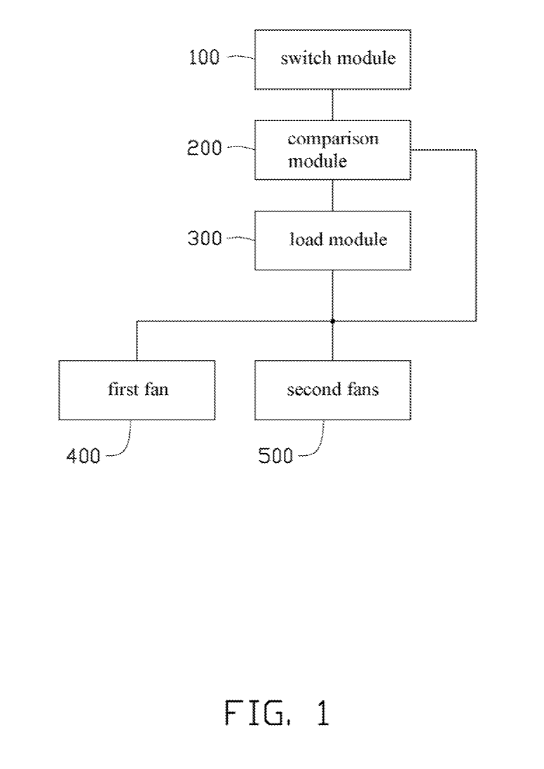

Referring to FIG. 1, a fan speed testing system for testing the rotational speed of a first fan 400 and a plurality of second fans 500, includes a switch module 100, a comparison module 200 and a load module 300.

The switch module 100 outputs control signals. The comparison module 200 receives the control signals and provides a first voltage to the load module 300 according to the control signals. The load module 300 receives the first voltage and outputs a second voltage to the first fan 400 and the plurality of second fans 500. The load module 300 feeds the second voltage received by the first fan 400 and the plurality of second fans 500 back to the comparison module 200. The comparison module 200 adjusts the first voltage to the load module 300 according to the second voltage which is fed back from the load module 300.

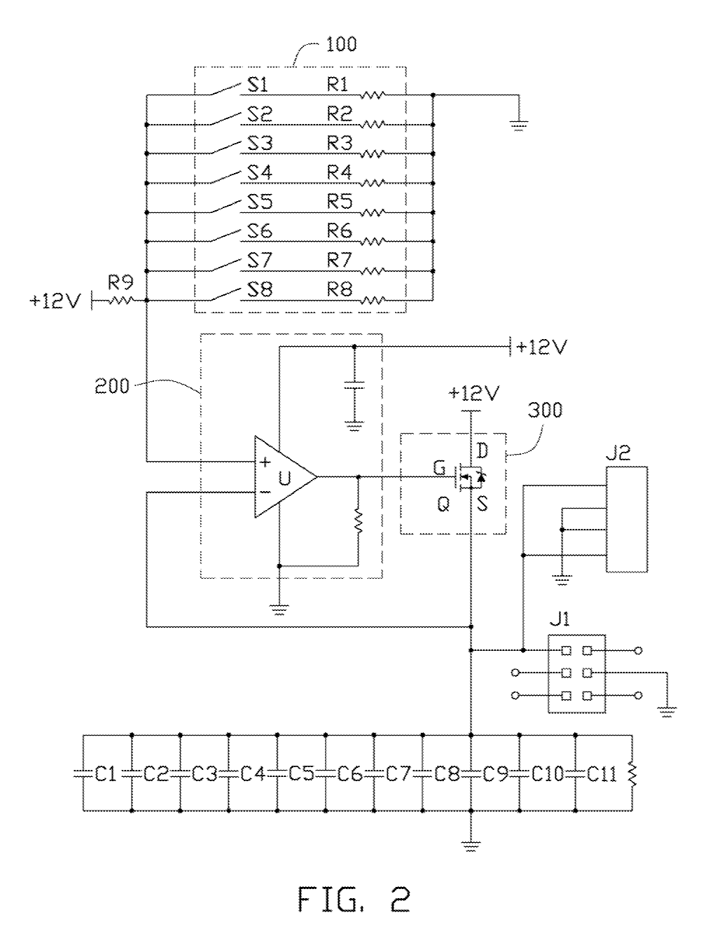

Referring to FIG. 2, the switch module 100 includes a first resistor R1, a second resistor R2, a third resistor R3, a fourth resistor R4, a fifth resistor R5, a sixth resistor R6, a seventh resistor R7, an eighth resistor R8, a ninth resistor R9, a first switch S1, a second switch S2, a third switch S3, a fourth switch S4, a fifth switch S5, a sixth switch S6, a seventh switch S7 and an eighth switch S8. The ninth resistor R9 includes a ninth resistor first terminal and a ninth resistor second terminal. The ninth resistor first terminal receives a DC voltage.

The first switch S1 and the first resistor R1 are electrically connected in series between the ninth resistor second terminal and ground. The second switch S2 and the second resistor R2 are electrically connected in series between the ninth resistor second terminal and ground. The third switch S3 and the third resistor R3 are electrically connected in series between the ninth resistor second terminal and ground. The fourth switch S4 and the fourth resistor R4 are electrically connected in series between the ninth resistor second terminal and ground.

The fifth switch S5 and the fifth resistor R5 are electrically connected in series between the ninth resistor second terminal and ground. The sixth switch S6 and the sixth resistor R6 are electrically connected in series between the ninth resistor second terminal and ground. The seventh switch S7 and the seventh resistor R7 are electrically connected in series between the ninth resistor second terminal and ground. The eighth switch S8 and the eighth resistor R8 are electrically connected in series between the ninth resistor second terminal and ground. In one embodiment, the DC voltage is +12 volts.

The comparison module 200 includes an integrated operational amplifier U. The integrated operational amplifier U includes an integrated operational amplifier non-inverting input terminal, an integrated operational amplifier inverting input terminal and an integrated operational amplifier output terminal. The integrated operational amplifier non-inverting input terminal is electrically connected to the ninth resistor second terminal for receiving the control signals. The integrated operational amplifier inverting input terminal receives the second voltage which is fed back from the load module 300. The integrated operational amplifier output terminal outputs the first voltage.

The load module 300 includes a MOSFET Q and a plurality of parallel capacitors C1-C11. The MOSFET Q includes a MOSFET gate, a MOSFET source and a MOSFET drain. The MOSFET grid receives the first voltage from the integrated operational amplifier output terminal. The MOSFET drain receives the +12 volts DC voltage. The MOSFET source is electrically connected to the first fan 400 via a fan connector J1. The MOSFET source is electrically connected to the plurality of second fans 500 via a power connector J2. The MOSFET source is electrically connected to the integrated operational amplifier inverting input terminal. The MOSFET source is grounded via the plurality of parallel capacitors C1-C11. In one embodiment, the MOSFET Q is a N-channel MOSFET. The fan connector J1 is a six-pin connector, the power connector J2 is a four-pin connector.

In use, one of the switches S1-S8 is closed to input the +12 volts DC voltage into the integrated operational amplifier non-inverting input terminal. The integrated operational amplifier U receives the control signals from the resistors R1-R8. The integrated operational amplifier output terminal outputs the first voltage. The MOSFET grid receives the first voltage. The MOSFET Q turns on. The MOSFET source outputs the second voltage to the fan connector J1 and the power connector J2 which is then provided to the first fan 400 and the plurality of second fans 500. In one embodiment, the +12 volts DC voltage is grounded via the integrated operational amplifier U, the MOSFET Q, and the first fan 400 in that sequence. Therefore, the integrated operational amplifier U is protected from damage should the +12 volts DC voltage be mistakenly connected to the circuit.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and the arrangement of parts within the principles of the disclosure to the full extent indicated by the broad general meaning of the terms in which the appended claims are expressed.

What is claimed is:

1. A fan speed testing system, for testing rotational speed of a first fan, comprising:
a switch module adapted to output control signals;
a comparison module adapted to receive the control signals and provide a first voltage according to the control signals; and
a load module adapted to receive the first voltage and output a second voltage to the first fan; wherein the load module is adapted to feed the second voltage received by the first fan back to the comparison module; and the comparison module is adapted to adjust the first voltage to the load module according to the second voltage which is fed back from the load module.

2. The fan speed testing system of claim 1, wherein the switch module comprises a plurality of first resistors, a second resistor and a plurality of switches; the second resistor comprises a second resistor first terminal and a second resistor second terminal; the second resistor first terminal is adapted to receive a DC voltage; and the plurality of first resistors and the plurality of switches are electrically connected in series between the second resistor second terminal and ground.

3. The fan speed testing system of claim 2, wherein the comparison module comprises an integrated operational amplifier; the integrated operational amplifier comprises an integrated operational amplifier non-inverting input terminal, an integrated operational amplifier inverting input terminal and an integrated operational amplifier output terminal; the integrated operational amplifier non-inverting input terminal is adapted to receive the control signals; the integrated operational amplifier inverting input terminal is adapted to receive the second voltage which is fed back from the load module; and the integrated operational amplifier output terminal is adapted to output the first voltage.

4. The fan speed testing system of claim 3, wherein the load module comprises a MOSFET; the MOSFET comprises a MOSFET grid, a MOSFET source and a MOSFET drain; the MOSFET grid is adapted to receive the first voltage from the integrated operational amplifier output terminal; the MOSFET drain is adapted to receive the DC voltage; the MOSFET source is electrically connected to the first fan; and the MOSFET source is electrically connected to the integrated operational amplifier inverting input terminal.

5. The fan speed testing system of claim 4, further comprising a fan connector and a power connector; the MOSFET source is electrically connected to the first fan via the fan connector; and the MOSFET source is electrically connected to a plurality of second fans via the power connector.

6. The fan speed testing system of claim 4, wherein the load module further comprises a plurality of parallel capacitors; and the MOSFET source is grounded via the plurality of parallel capacitors.

7. The fan speed testing system of claim 2, wherein the DC voltage is +12 volts.

8. The fan speed testing system of claim 4, wherein the MOSFET is a N-channel MOSFET.

9. A fan speed testing system for testing rotational speed of a first fan and a plurality of second fans, comprising:
a switch module adapted to output control signals;
a comparison module adapted to receive the control signals and provide a first voltage according to the control signals; and
a load module adapted to receive the first voltage and output a second voltage to the first fan via a fan connector; the load module is adapted to output the second voltage to the plurality of second fans via a power connector; wherein the load module is adapted to feed the second voltage received by the first fan back to the comparison module; and the comparison module is adapted to adjust the first voltage to the load module according to the second voltage which is fed back from the load module.

10. The fan speed testing system of claim 9, wherein the switch module comprises a plurality of first resistors, a second resistor and a plurality of switches; the second resistor comprises a second resistor first terminal and a second resistor second terminal; the second resistor first terminal is adapted to receive a DC voltage; and the plurality of first resistors and the plurality of switches are electrically connected in series between the second resistor second terminal and ground.

11. The fan speed testing system of claim 10, wherein the comparison module comprises an integrated operational amplifier; the integrated operational amplifier comprises an integrated operational amplifier non-inverting input terminal, an integrated operational amplifier inverting input terminal and an integrated operational amplifier output terminal; the integrated operational amplifier non-inverting input terminal is adapted to receive the control signals; the integrated operational amplifier inverting input terminal is adapted to receive the second voltage which is fed back from the load module; and the integrated operational amplifier output terminal is adapted to output the first voltage.

12. The fan speed testing system of claim 11, wherein the load module comprises a MOSFET; the MOSFET comprises a MOSFET grid, a MOSFET source and a MOSFET drain; the MOSFET grid is adapted to receive the first voltage from the integrated operational amplifier output terminal; the MOSFET drain is adapted to receive the DC voltage; the MOSFET source is electrically connected to the first fan; the MOSFET source is electrically connected to the integrated operational amplifier inverting input terminal; the MOSFET source is electrically connected to the first fan via the fan connector; and the MOSFET source is electrically connected to the plurality of second fans via the power connector.

13. The fan speed testing system of claim 12, wherein the load module further comprises a plurality of parallel capacitors; and the MOSFET source is grounded via the plurality of parallel capacitors.

14. The fan speed testing system of claim 10, wherein the DC voltage is +12 volts.

15. The fan speed testing system of claim 12, wherein the MOSFET is a N-channel MOSFET.
